(19) United States
(12) Patent Application Publication
(10) Pub. No.: US 2010/0180042 A1
(43) Pub. Date: Jul. 15, 2010

(54) Simulcast Flow-Controlled Data Streams

(75) Inventors: David James Gemmell, Alamo, CA (US); Asad Yaqoob, Redmond, WA (US); Alaa H. Abdelhalim, Bellevue, WA (US); Seunghwan Hong, Pittsburgh, PA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/352,829

(22) Filed: Jan. 13, 2009

(51) Int. Cl. G06F 15/16; H04H 20/71

(52) U.S. Cl. 709/231; 455/3.01

(57) ABSTRACT

Simulcast flow-controlled data streams is described. In embodiment(s), multicast data streams each communicate data to client devices at a different data rate. A high data rate of a first data stream can be reduced to accommodate a receive data rate of a client device that receives the data slower than the high data rate of the first data stream. A flow control service can monitor the high data rate of the first data stream to determine when the high data rate is reduced to a low trigger data rate, initiate a data stream probe at a probe data rate to determine slow client devices that receive the data slower than the probe data rate, and then demote the slow client devices for communication with a second data stream that communicates the data at a low data rate.

### BACKGROUND

Software updates and downloads, as well as other types of data, are distributed from networked servers to various wired and/or wireless client devices via communication and data distribution networks. In a conventional data distribution scheme to deliver data to multiple client devices, even one device that has a slow receive data rate can slow down the overall session rate to the slow receive rate for all of the other devices. A slow receiving client device can be caused by various factors, such as the device entering a sleep mode, a slow wireless connection, a defective disk drive that causes data write errors, a slow processor due to a virus or problematic application, a faulty network switch or router, and/or any number of other factors. In a conventional data distribution scheme, a new client device that requests to join a session is typically started in the slowest group of devices so as not to impact the session rate of a faster group of the devices, even if the new client device is itself capable of receiving data at the faster data rate, because a slow receiving client device can slow down the overall session rate for all of the other devices.

### SUMMARY

This summary is provided to introduce simplified concepts of simulcast flow-controlled data streams. The simplified concepts are further described below in the Detailed Description. This summary is not intended to identify essential features of the claimed subject matter, nor is it intended for use in determining the scope of the claimed subject matter.

Simulcast flow-controlled data streams is described. In embodiment(s), multicast data streams each communicate data to client devices at a different data rate. A high data rate of a first data stream can be reduced to accommodate a receive data rate of a client device that receives the data slower than the high data rate of the first data stream. A flow control service can monitor the high data rate of the first data stream to determine when the high data rate is reduced to a low trigger data rate, initiate a data stream probe at a probe data rate to determine slow client devices that receive the data slower than the probe data rate, and then demote the slow client devices for communication with a second data stream that communicates the data at a low data rate.

In other embodiment(s) of simulcast flow-controlled data streams, the flow control service can monitor the high data rate of the first data stream as it is being reduced by communicating with whichever client device receives the data from the first data stream the slowest. Alternatively or in addition, the flow control service can communicate with an elected client device and/or other slow client devices that receive the data slower than the probe data rate. For new client devices that join the service to receive the data, the flow control service can communicate a time-to-join indication to batch join a group of new client devices to receive the data via the multicast data streams. The flow control service can initiate that the data is initially communicated from the first data stream to a new client device that joins to receive the data.

### BRIEF DESCRIPTION OF THE DRAWINGS

Embodiments of simulcast flow-controlled data streams are described with reference to the following drawings. The same numbers are used throughout the drawings to reference like features and components:

FIG. 1 illustrates an example system in which embodiments of simulcast flow-controlled data streams can be implemented.

FIG. 2 illustrates an example of simulcast flow-controlled data streams in accordance with one or more embodiments.

FIG. 3 illustrates example method(s) for simulcast flow-controlled data streams in accordance with one or more embodiments.

FIG. 4 illustrates various components of an example device that can receive data in accordance with one or more embodiments of simulcast flow-controlled data streams.

### DETAILED DESCRIPTION

Embodiments of simulcast flow-controlled data streams provide that slow client devices having a slow receive data rate are demoted from a first data stream that communicates data at a high data rate to a second data stream that communicates the data at a lower data rate. The session rate, or data flow, for each multicast data stream of a simulcast can be controlled when the slow client devices for a particular session are identified and demoted to receive the data from a data stream having a next slowest session rate. This provides that relatively slow client devices only have a short-term and minimal effect on the download speed and/or data reception of relatively faster client devices associated with a multicast data stream that communicates at a high data rate.

In embodiments, the transmission data rate of a data stream can be monitored by communicating with a selected client device that receives the data the slowest because the slow device controls the transmission data rate for the session. The receive data rate of the slow client device can be determined from time durations for packet communication and subsequent acknowledgements. When the session data rate for the multicast data stream is slowed to a low trigger data rate, a data stream probe can be initiated to determine other slow client devices that may also receive the data slower than the probe data rate. The slow client devices can then be demoted together for communication with a next slowest session that communicates the data at a lower data rate to accommodate the slow receive data rates of the devices.

While features and concepts of the described systems and methods for simulcast flow-controlled data streams can be implemented in any number of different environments, systems, and/or various configurations, embodiments of simulcast flow-controlled data streams are described in the context of the following example systems and environments.

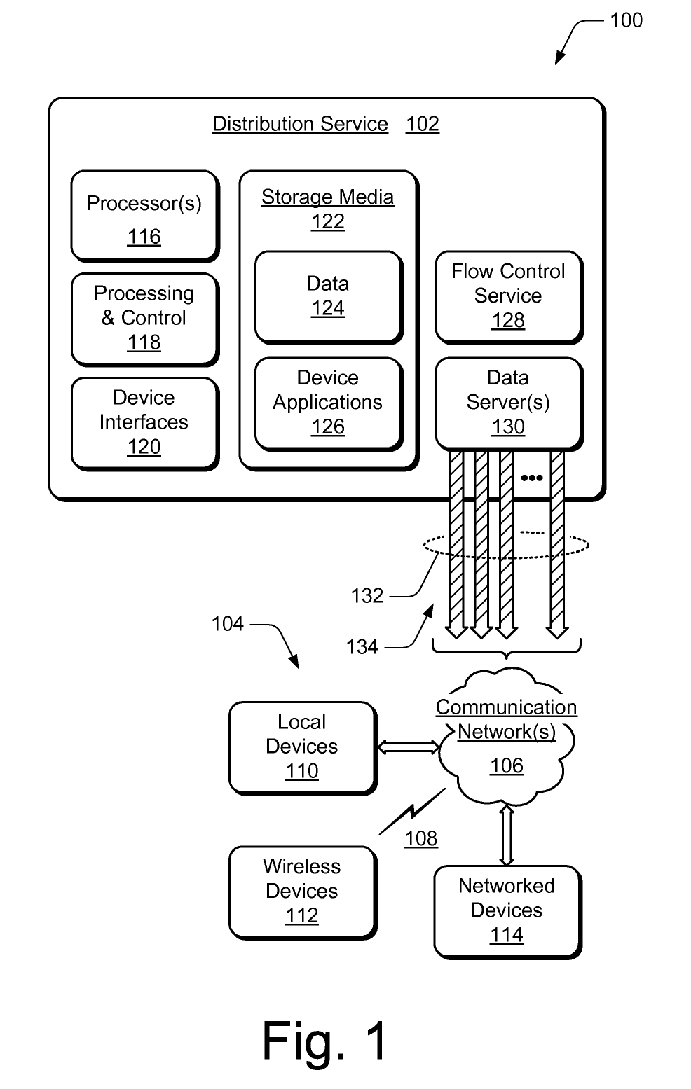

FIG. 1 illustrates an example system 100 in which various embodiments of simulcast flow-controlled data streams can be implemented. Example system 100 includes a distribution service 102, and can include any other data or content sources that distribute any type of data, content, updates, and/or downloads (collectively referred to as data) to various client devices 104 via one or more communication networks 106.

The distribution service 102 and the various client devices 104 are implemented for communication via the communication networks 106 that can include any type of a data network, voice network, broadcast network, IP-based network, and/or a wireless network 108 that facilitates communication of data in any format. The communication networks 106 and wireless network 108 can be implemented using any type of network topology and/or communication protocol, and can be represented or otherwise implemented as a combination of two or more networks. In addition, any one or more of the arrowed communication links facilitate two-way data communication.

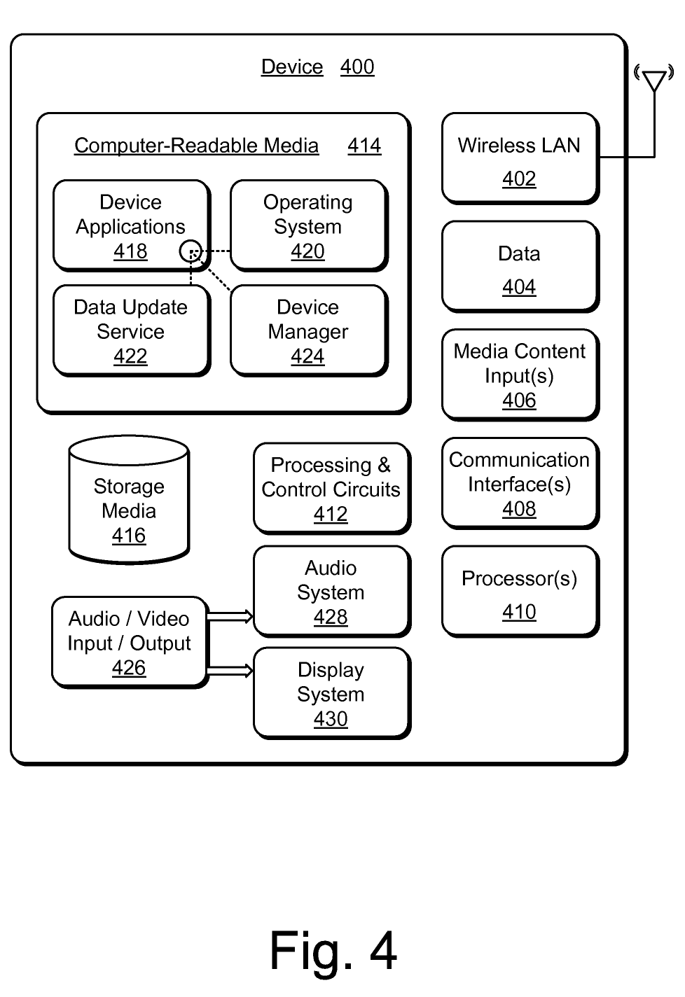

The client devices 104 can include local devices 110, wireless devices 112, and/or other types of networked devices 114. The various client devices 104 can include any one or combination of a wired and/or wireless device, mobile phone device, portable computer device, media device, computer device, communication device, video processing and/or rendering device, appliance device, gaming device, electronic device, and/or any other type of device that may be implemented to receive data, such as a software update or download. Any of the client devices described herein can be implemented with one or more processors, communication components, data inputs, memory components, and/or processing and control circuits. A client device can also be implemented with any number and combination of differing components as described with reference to the example device shown in FIG. 4.

In this example system 100, distribution service 102 includes one or more processors 116 (e.g., any of microprocessors, controllers, and the like) that process various computer-executable instructions to implement embodiments of simulcast flow-controlled data streams. Alternatively or in addition, distribution service 102 can be implemented with any one or combination of hardware, firmware, or fixed logic circuitry that is implemented in connection with processing and control which is generally identified at 118. Although not shown, distribution service 102 can include a system bus or data transfer system that couples the various components within the service.

Distribution service 102 also includes one or more device interfaces 120 that can be implemented as a serial and/or parallel interface, a wireless interface, any type of network interface, a modem, and/or as any other type of communication interface. The device interfaces 120 provide connection and/or communication links between distribution service 102 and the communication networks 106 by which to communicate data with the various client devices 104.

Distribution service 102 also includes storage media 122 to store or otherwise maintain various data and media content, such as data 124 for distribution to the various client devices 104. The data 124 can include any type of software update or download, or other types of content and data. The storage media 122 can be implemented as any type of memory, magnetic or optical disk storage, and/or other suitable electronic data storage. The storage media 122 can also be referred to or implemented as computer-readable media, such as one or more memory components, that provide data storage mechanisms to store data, as well as various device applications 126 and any other types of information and/or data related to operational aspects of the distribution service 102. For example, an operating system and/or software modules and components can be maintained as computer applications with the storage media 122 and executed on the processors 116.

Distribution service 102 includes a flow control service 128 that can be implemented as computer-executable instructions and executed by the processors 116 to implement embodiments of simulcast flow-controlled data streams. In an implementation, the flow control service 128 is an example of a device application 126 that is maintained by the storage media 122. Although illustrated and described as a component or module of distribution service 102, the flow control service 128, as well as other functionality to implement the various embodiments described herein, can be provided as a service apart from the distribution service 102 (e.g., on a separate server or by a third party service).

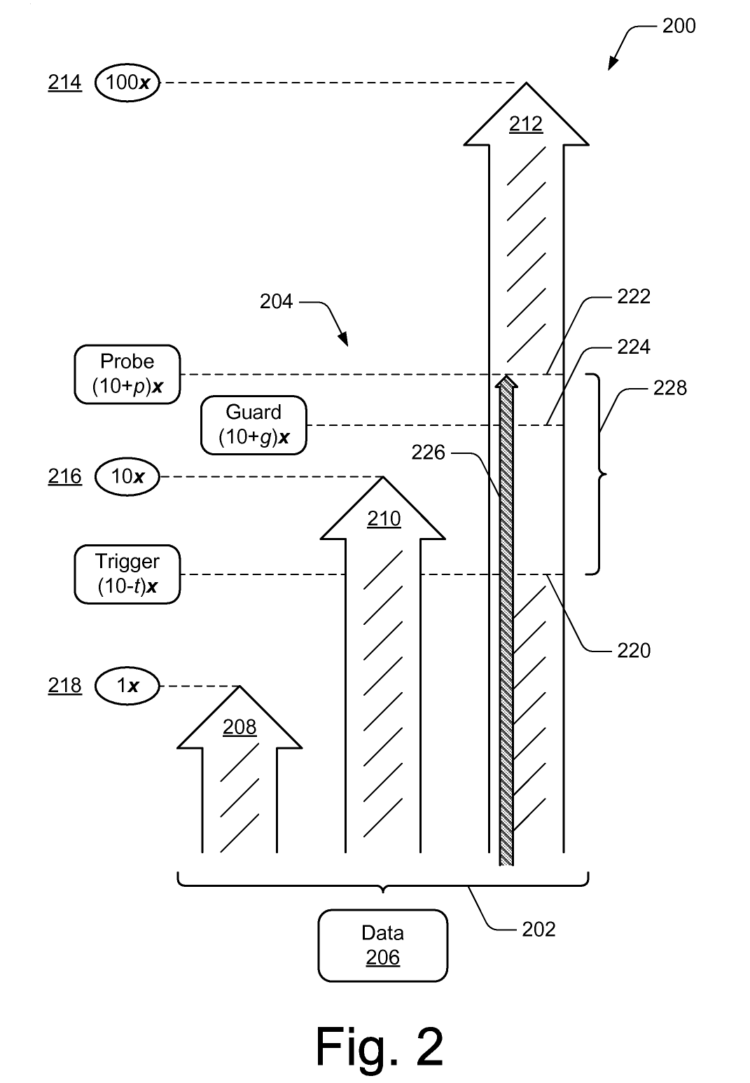

In various embodiments, the flow control service 128 can be implemented to control one or more data servers 130 that are implemented to communicate or otherwise distribute data to the various client devices 104. The data servers 130 can be implemented to distribute the data 124 as a simulcast 132 of separate multicast data streams 134 that each communicate the data 124 to the various client devices 104 at a different data rate. Each of the multicast data streams 134 communicate data to multiple client devices that each tune into one data stream, or channel, at a time. A data stream 134 may also be referred to as a channel or a session when communicating with a client device. An example of simulcast flow-controlled data streams communicated to client devices is described with reference to FIG. 2.

FIG. 2 illustrates an example 200 of simulcast flow-controlled data streams. In this example, a simulcast 202 includes multicast data streams 204 that can be flow-controlled and utilized to communicate data 206 to various client devices from a distribution service, such as described with reference to FIG. 1. The flow-controlled, multicast data streams 204 include a data stream 208 that communicates the data at a 1x data rate, a date stream 210 that communicates the data at a 10x data rate, and a data stream 212 that communicates the data at a 100x data rate (e.g., where the data rate is x megabits/sec).

Each of the data streams 204 can be implemented with a fixed maximum bandwidth, and each successive data stream has a faster data rate than the previous by about an order of magnitude. By communicating with a client device at a data rate that the client device is able to receive the data, other client devices in a faster session are not slowed down by more than an order of magnitude. The three flow-controlled, multicast data streams 204 are merely exemplary to illustrate one or more embodiments of simulcast flow-controlled data streams, and in practice may include any number of data streams in a simulcast that communicate the data at various data rates.

The multicast data streams 204 include data stream 212 that can communicate the data at a high data rate 214 (e.g., at 100x) and include data stream 210 that can communicate the data at a low data rate 216 (e.g., at 10x). Similarly, data stream 210 can be described as the data stream that communicates the data at a high data rate 216 (e.g., at 10x) comparatively with data stream 208 that communicates the data a low data rate 218 (e.g., at 1x). The designation of a data rate as being either high or low is not meant to indicate a particular numeric high or low data rate, but is meant only to indicate that a first data rate is faster than a second data rate and conversely, the second data rate is slower than the first data rate, comparatively. The data rate of each data stream 204 can be adjusted or reduced to communicate the data to various client devices at less than the described high data rate for each respective data stream 204.

In an example for discussion purposes, data stream 212 communicates the data to various client devices at a high data rate of 100 Mb/s at 214 (e.g., where x=1 megabit/sec) and data stream 210 communicates the data to various client devices at a low data rate of 10 Mb/s at 216. In this example, data stream 212 has an associated low trigger data rate of 8 Mb/s at 220 for a trigger data rate of (10−t)x where t=2. In other embodiments, the low trigger data rate can be configurable at any data rate, and optionally, set at less than the maximum data rate of the next slowest session which is the low data rate of 10 Mb/s at 216 for data stream 210. Data stream 212 also has an associated probe data rate of 20 Mb/s at 222 for a probe data rate of (10+p)x where p=10. In other embodiments, the probe data rate can be configurable at any data rate, and optionally, set at more than the maximum data rate of the next slowest session which is the low data rate of 10 Mb/s at 216 for data stream 210. Data stream 212 also has an associated guard data rate of 12 Mb/s at 224 for a guard data rate of (10+g)x where g=2. In other embodiments, the guard data rate can be configurable at any data rate, and optionally, set at more than the maximum data rate of the next slowest session and less than the probe data rate of the current session.

In embodiments, the flow control service 128 described with reference to FIG. 1 can be implemented to monitor the high data rate of 100 Mb/s of data stream 212 to determine when the high data rate is reduced to the low trigger data rate of 8 Mb/s at 220. Over time, a session can communicate data at any rate between the high data rate of the data stream at 214 and the low trigger data rate at 220. As the data is distributed, the high data rate of data stream 212 can be reduced to accommodate a receive data rate of a client device that receives the data slower than the high data rate of the data stream. In an embodiment, the client device that receives the data the slowest for the session can be designated to communicate with flow control service 128 that monitors the data rate of the data stream because the slowest client device controls the data rate and flow of data transmission for the session. The receive data rate of the client device can be determined from time durations for packet communication and subsequent acknowledgements. Alternatively or in addition, the flow control service 128 can monitor the data rate of the data stream by way of communication with more than one of the slow client devices.

If the receive data rate of the slow client device drops to the low trigger data rate of 8 Mb/s at 220 or below, then the flow control service 128 is implemented to initiate a data stream probe 226 at the probe data rate of 20 Mb/s at 222 to determine other possible slow client devices that receive the data slower than the probe data rate. In this example, the low trigger data rate of 8 Mb/s for data stream 212 is lower than the set maximum bandwidth of the next slowest session which is the low data rate of 10 Mb/s at 216 for data stream 210. A drop in the transmission data rate of a session indicates that other slow client devices, in addition to the client device that receives the data the slowest for the session, may be slowing communication of the data for the entire session and for the other connected devices.

The flow control service 128 can initiate the data stream probe 226 as a series of data packets that are communicated to the client devices, and those client devices that fail to timely acknowledge the data packets are determined to be the slow client devices that receive the data slower than the probe data rate. In this example, the slow client devices are determined as those that receive the data from data stream 212 slower than the probe data rate at 222 and/or faster than the low trigger data rate at 220 in a slow client device window 228. Alternatively, the slow client devices can be determined as those that receive the data from data stream 212 slower than or equal to the probe data rate at 222 and/or faster than or equal to the low trigger data rate at 220 in the slow client device window 228. The flow control service 128 can receive negative acknowledgment packets and the client devices that indicate a loss rate greater than a set percentage are included in a list for demotion to the next slowest session, which in this example is data stream 210.

Utilizing a probe data rate at a bandwidth higher than the maximum data rate of the next slowest session can distinguish between client devices that are significantly faster than the slowest client device and other slow client devices. In embodiments, the flow control service 128 can be implemented to initiate a data stream probe as needed, such as when the transmission data rate of the session is slowed to the low trigger data rate of 8 Mb/s at 220. If the transmission data rate of the data stream communicates the data faster then the low trigger data rate, or optionally another configurable data rate, then the flow control service 128 may not initiate data stream probes.

In embodiments for data stream flow control, the flow control service 128 can be implemented to demote a group of slow client devices to communicate with data stream 210 that communicates the data at the low data rate of 10 Mb/s. In one embodiment, the flow control service 128 can communicate a probe confirmation signal to a slow client device that demotes itself and then initiates communication with data stream 210 to receive the data at the low data rate. In another embodiment, the flow control service 128 can communicate a demote instruction signal to the slow client devices, such as a demote message in the form of data packet communicated to a slow client device. Alternatively or in addition, a client device with no reception after a time threshold can determine itself demoted.

When the slow client devices are demoted from data stream 212 and down to data stream 210, the data rate for data stream 212 increases and the data can be communicated at a data rate that is faster or above the guard data rate of 12 Mb/s at 224. When these slow client devices are demoted as a group, the session data rate for data stream 212 increases to a higher data rate more quickly than if each slow client device was demoted individually, one after the other as detected.

In embodiments of flow-controlled data streams, the example described above to demote slow client devices from data stream 212 down to data stream 210 is similarly applicable to demote slow client devices from data stream 210 down to data stream 208. For example, data stream 210 that communicates the data at a high data rate 216 (e.g., at 10 Mb/s) can have an associated low trigger data rate of 0.8 Mb/s (optionally configurable) which is less than the maximum data rate of the next slowest session which is the low data rate of 1 Mb/s at 218 for data stream 208. Data stream 210 can also have an associated probe data rate of 1.2 Mb/s (optionally configurable) which is more than the maximum data rate of the next slowest session which is the low data rate of 1 Mb/s at 218 for data stream 208. Data stream 210 can also have an associated guard data rate of 1.1 Mb/s (optionally configurable) which is more than the maximum data rate of the next slowest session and less than the probe data rate of the current session.

In embodiments, the flow control service 128 described with reference to FIG. 1 can be implemented to monitor the high data rate of 10 Mb/s of data stream 210 to determine when the high data rate is reduced to the low trigger data rate of 0.8 Mb/s. If the receive data rate of a slow client device drops to the low trigger data rate of 0.8 Mb/s or below, then a data stream probe can be initiated at the probe data rate of 1.2 Mb/s to determine other possible slow client devices that receive the data slower than the probe data rate. A group of slow client devices can then be demoted to communicate with data stream 208 that communicates the data at the relatively lower data rate of 1 Mb/s. The data rate for data stream 210 then increases and the data can be communicated at a data rate that is faster or above the guard data rate of 1.1 Mb/s.

In various embodiments, the flow control service 128 can also be implemented to join a group of new client devices to receive the data via the multicast data streams 204. The flow control service 128 can communicate a time-to-join indication to batch join a group of new client devices that initially receive the data from data stream 212 which, in this example, is the fastest data stream having the data rate of 100 Mb/s at 214. New client devices that communicate a request to join the session are instructed with a time-to-join so that each client device is not connecting to receive the data one device at a time, but rather is joined with other client devices in a batch group. In an implementation, join acknowledgement data packets can be communicated to include a time-to-join value that indicates a time duration to wait before joining the session.

In other embodiments, the flow control service 128 can also be implemented to initiate promotion of client devices from data stream 210 (e.g., those client devices that are slow client devices) for communication with data stream 212 when the receive data rate of the client devices in the session exceeds the maximum data rate of the data stream. In this example, client devices that receive data from data stream 210, and that have a receive data rate that exceeds the session data rate of 10 Mb/s at 216, can be promoted to receive the data from data stream 212 at the higher data rate. In an embodiment, promotion of the client devices from data stream 210 to data stream 212 can be implemented without probing and can be automatic when the receive data rate for the client devices exceeds the session data rate. In an implementation, various ones of the client devices that exceed the session data rate can be promoted to the next successive data stream that has the higher data rate. Alternatively, the client devices associated with data stream 210 can be promoted to data stream 212 when all of the client devices have a receive data rate that exceeds the session data rate.

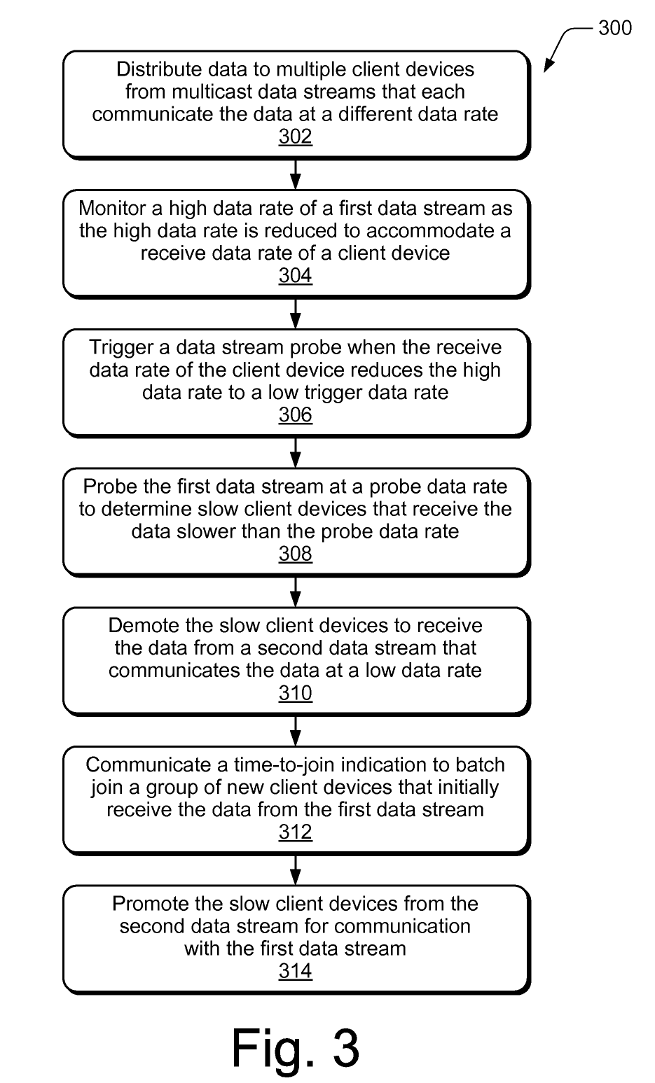

Example method 300 is described with reference to FIG. 3 in accordance with one or more embodiments of simulcast flow-controlled data streams. Generally, any of the functions, methods, procedures, components, and modules described herein can be implemented using hardware, software, firmware, fixed logic circuitry, manual processing, or any combination thereof. A software implementation of a function, method, procedure, component, or module represents program code that performs specified tasks when executed on a computing-based processor. The method(s) may be described in the general context of computer-executable instructions, which can include software, applications, routines, programs, objects, components, data structures, procedures, modules, functions, and the like.

The method(s) may also be practiced in a distributed computing environment where functions are performed by remote processing devices that are linked through a communication network. In a distributed computing environment, computer-executable instructions may be located in both local and remote computer storage media, including memory storage devices. Further, the features described herein are platform-independent such that the techniques may be implemented on a variety of computing platforms having a variety of processors.

FIG. 3 illustrates example method(s) 300 of simulcast flow-controlled data streams. The order in which the method is described is not intended to be construed as a limitation, and any number of the described method blocks can be combined in any order to implement the method, or an alternate method.

At block 302, data is distributed to multiple client devices from multicast data streams that each communicate the data at a different data rate. For example, a simulcast 202 (FIG. 2) includes multicast data streams 204 that are flow-controlled and utilized to communicate data 206 to various client devices from a distribution service, such as described with reference to FIG. 1. The flow-controlled, multicast data streams 204 include a data stream 208 that communicates the data at a 1x data rate, a date stream 210 that communicates the data at a 10x data rate, and a data stream 212 that communicates the data at a 100x data rate. Comparatively, the multicast data streams include data stream 212 that communicates the data at the high data rate 214, and data stream 210 that communicates the data at the low data rate 216. Similarly, the multicast data streams can be described to include data stream 210 that communicates the data at the high data rate 216, and data stream 208 that communicates the data at the low data rate 218. Note that in some examples, a first data stream is referred to as data stream 212 and a second data stream is referred to as data stream 210, and in other examples, a first data stream is referred to as data stream 210 and a second data stream is referred to as data stream 208. The reference to a first data stream and a second data stream is merely relative to include any two data streams in a group of several multicast data streams.

At block 304, a high data rate of a first data stream is monitored as the high data rate is reduced to accommodate a receive data rate of a client device. For example, flow control service 128 (FIG. 1) monitors the high data rate of 100 Mb/s of data stream 212 to determine when the high data rate is reduced to the low trigger data rate of 8 Mb/s at 220. As the data is distributed, the high data rate of data stream 212 can be reduced to accommodate slow receive data rates of client devices that receive the data slower. In an embodiment, the flow control service 128 communicates with the slowest client device, or alternatively more than one of the slow client devices, to monitor the session data rate as it is being reduced to accommodate the slow receive data rates of the one or more slow client devices. Similarly, the flow control service 128 monitors the high data rate of 10 Mb/s of data stream 210 to determine when the high data rate is reduced to a lower trigger data rate for the data stream (e.g., less than the maximum data rate of the next slowest session which is the low data rate of 1 Mb/s at 218 for data stream 208).

At block 306, a data stream probe is triggered when the receive data rate of the client device reduces the high data rate to a low trigger data rate. For example, the flow control service 128 triggers data stream probe 226 when the receive data rate of the slow client device drops to the low trigger data rate at 220 or below. At block 308, the first data stream is probed at a probe data rate to determine slow client devices that receive the data slower than the probe data rate. For example, the flow control service 128 probes data stream 212 to determine other slow client devices that may be slowing communication of the data for the entire session, and that receive the data slower than the probe data rate at 222.

At block 310, the slow client devices are demoted to receive the data from a second data stream that communicates the data at a low data rate. For example, the flow control service 128 demotes the slow client devices to communicate with data stream 210 that communicates the data at the relatively lower data rate at 216. Similarly, the flow control service 128 demotes the slow client devices that communicate with data stream 210 to communicate with data stream 208 that communicates the data at the relatively lower data rate at 218. In an embodiment, the flow control service 128 communicates a probe confirmation signal to a slow client device that demotes itself to then initiate communication with data stream 210 to receive the data at the low data rate. In another embodiment, the flow control service 128 communicates a demote instruction signal to the slow client devices.

At block 312, a time-to-join indication is communicated to batch join a group of new client devices that initially receive the data from the first data stream. For example, the flow control service 128 communicates a time-to-join indication to batch join a group of new client devices that initially receive the data from data stream 212 which communicates the data at the faster data rate at 214. New client devices that communicate a request to join the session are instructed with a time-to-join so that each client device is not connecting to receive the data one device at a time.

At block 314, the slow client devices are promoted from the second data stream for communication with the first data stream. For example, the flow control service 128 promotes client devices from data stream 210 (e.g., those client devices that are comparatively the slow client devices) for communication with data stream 212 when the receive data rate of the client devices in the session exceeds the maximum data rate of the slower data stream.

FIG. 4 illustrates various components of an example device 400 that can be implemented as any type of device that receives data in accordance with one or more embodiments of simulcast flow-controlled data streams. In embodiment(s), device 400 can be implemented as any one or combination of a wired and/or wireless device, a mobile phone device, a portable computer device, media device, computer device, communication device, video processing and/or rendering device, appliance device, gaming device, electronic device, and/or as any other type of device that may be implemented to receive data, such as a software update or download. Device 400 may also be associated with a user (i.e., a person) and/or an entity that operates the device such that a device describes logical devices that include users, software, firmware, and/or a combination of devices.

Device 400 can also include wireless LAN (WLAN) components 402, that enable wireless communication of data 404 (e.g., received data, data that is being received, data scheduled for broadcast, data packets of the data, etc.). Device 400 can also include one or more media content input(s) 406 via which any type of media content can be received, such as music, television media content, video content, and any other type of audio, video, and/or image media content received from a media content source which can be processed, rendered, and/or displayed for viewing.

Device 400 can also include communication interface(s) 408 that can be implemented as any one or more of a serial and/or parallel interface, a wireless interface, any type of network interface, a modem, and as any other type of communication interface. A wireless interface enables device 400 to receive control input commands and other data from an input device, such as from a remote control device, a portable computing-based device (such as a cellular phone), or from another infrared (IR) or similar RF input device.

Device 400 can also include one or more processor(s) 410 (e.g., any of microprocessors, controllers, and the like) which process various computer-executable instructions to control the operation of device 400, to communicate with other electronic and computing devices, and to implement various embodiments as described herein. Alternatively or in addition, device 400 can be implemented with any one or combination of hardware, firmware, or fixed logic circuitry that is implemented in connection with processing and control circuits which are generally identified at 412.

Device 400 can include computer-readable media 414, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), any type of a digital versatile disc (DVD), and the like. Device 400 can also include a mass storage media device 416.

Computer-readable media 414 provides data storage mechanisms to store the data 404, as well as various device applications 418 and any other types of information and/or data related to operational aspects of device 400. For example, an operating system 420 can be maintained as a computer application with the computer-readable media 414 and executed on processor(s) 410. In one or more embodiments, the device applications 418 can also include a data update service 422 and/or a device manager 424 when device 400 is implemented to receive simulcast flow-controlled data streams. In this example, the device applications 418 are shown as software modules and/or computer applications.

Device 400 can also include an audio and/or video input/output system 426 that provides audio data to an audio system 428 and/or provides video data to a display system 430. The audio system 428 and/or the display system 430 can include any devices that process, display, and/or otherwise render audio, video, and image data. Video signals and audio signals can be communicated from device 400 to an audio device and/or to a display device via an RF (radio frequency) link, S-video link, composite video link, component video link, DVI (digital video interface), analog audio connection, or other similar communication link. In an embodiment, audio system 428 and/or the display system 430 can be implemented as external components to device 400. Alternatively, the audio system 428 and/or the display system 430 can be implemented as integrated components of example device 400.

Although not shown, device 400 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Although embodiments of simulcast flow-controlled data streams have been described in language specific to features and/or methods, it is to be understood that the subject of the appended claims is not necessarily limited to the specific features or methods described. Rather, the specific features and methods are disclosed as example implementations of simulcast flow-controlled data streams.

1. A data distribution system, comprising:
multicast data streams each configured to communicate data to client devices at a different data rate, the multicast data streams including at least a first data stream configured to communicate the data at a high data rate and a second data stream configured to communicate the data at a low data rate, the high data rate of the first data stream being reduced to accommodate a receive data rate of a client device that receives the data slower than the high data rate of the first data stream;
a flow control service configured to:
monitor the high data rate of the first data stream to determine when the high data rate is reduced to a low trigger data rate;
initiate a data stream probe at a probe data rate to determine slow client devices that receive the data slower than the probe data rate; and
demote the slow client devices for communication with the second data stream that is configured to communicate the data at the low data rate.

2. A data distribution system as recited in claim 1, wherein the flow control service is further configured to monitor at least the high data rate of the first data stream as it is being reduced through communication with the client device that receives the data from the first data stream the slowest.

3. A data distribution system as recited in claim 1, wherein the flow control service is further configured to monitor at least the high data rate of the first data stream that is being reduced through communication with one or more of the slow client devices that receive the data slower than the probe data rate.

4. A data distribution system as recited in claim 1, wherein the flow control service is further configured to communicate a time-to-join indication to a group of new client devices to batch join the new client devices to receive the data via the multicast data streams.

5. A data distribution system as recited in claim 1, wherein the flow control service is further configured to initially communicate the data from the first data stream to a new client device that joins to receive the data via the multicast data streams.

6. A data distribution system as recited in claim 5, wherein the flow control service is further configured to:
determine that the new client device receives the data slower than the probe data rate; and
demote the new client device to receive the data from the second data stream.

7. A data distribution system as recited in claim 1, wherein the flow control service is further configured to communicate a probe confirmation signal to a slow client device that then initiates communication with the second data stream to receive the data.

8. A data distribution system as recited in claim 1, wherein the flow control service is further configured to communicate a demote instruction signal to a slow client device.

9. A data distribution system as recited in claim 1, wherein the flow control service is further configured to initiate promotion of the slow client devices from the second data stream for communication with the first data stream when the receive data rate of the slow client devices exceeds a maximum data rate of the second data stream.

10. A method, comprising:
monitoring a high data rate of a first data stream as the high data rate is reduced to accommodate a receive data rate of a client device that receives data slower than the high data rate;
triggering a data stream probe when the receive data rate of the client device reduces the high data rate to a low trigger data rate;
probing at a probe data rate to determine slow client devices that receive the data slower than the probe data rate; and
demoting the slow client devices to receive the data from a second data stream that communicates the data at a low data rate.

11. A method as recited in claim 10, further comprising distributing the data to multiple client devices from multicast data streams that each communicate the data at a different data rate, the multicast data streams including at least the first data stream that communicates the data at the high data rate and the second data stream that communicates the data at the low data rate.

12. A method as recited in claim 10, further comprising communicating with the client device that receives the data the slowest to monitor at least the high data rate of the first data stream as it is being reduced to accommodate the receive data rate of the client device.

13. A method as recited in claim 10, further comprising communicating with one or more of the slow client devices that receive the data slower than the probe data rate to monitor at least the high data rate of the first data stream as it is being reduced.

14. A method as recited in claim 10, further comprising communicating a time-to-join indication to batch join a group of new client devices that initially receive the data from the first data stream.

15. A method as recited in claim 14, further comprising:
determining that a new client device receives the data slower than the probe data rate; and
demoting the new client device to receive the data from the second data stream.

16. A method as recited in claim 10, further comprising communicating a probe confirmation signal to a slow client device that then initiates communication with the second data stream to receive the data.

17. A method as recited in claim 10, further comprising communicating a demote instruction signal to a slow client device.

18. A method as recited in claim 10, further comprising promoting the slow client devices from the second data stream for communication with the first data stream when the receive data rate of the slow client devices exceeds a maximum data rate of the second data stream.

19. Computer-readable media comprising computer-executable instructions that, when executed, initiate a flow control service to:
monitor a high data rate of a first data stream as the high data rate is reduced to accommodate a receive data rate of one or more client devices that receive data slower than the high data rate;
trigger a data stream probe when the receive data rate of the one or more client devices reduces the high data rate to a low trigger data rate;
probe at a probe data rate to determine slow client devices that receive the data slower than the probe data rate; and
demote the slow client devices to receive the data from a second data stream that communicates the data at a low data rate.

20. Computer-readable media as recited in claim 19, further comprising computer-executable instructions that, when executed, initiate the flow control service to:
join a new client device that initially receives the data from the first data stream;
determine that the new client device receives the data slower than the probe data rate; and
demote the new client device to receive the data from the second data stream.
